(19) United States
(12) Patent Application Publication
(10) Pub. No.: US 2013/0008919 A1
(43) Pub. Date: Jan. 10, 2013

(54) APPARATUS AND METHODS FOR DISPENSING FLUID

(75) Inventors: David Honan, Concord, MA (US); Shane Yellin, Dover, MA (US); Mike Price, Pelham, NH (US)

(73) Assignee: PERIMETER BRAND PACKAGING, Northborough, MA (US)

(21) Appl. No.: 13/544,433

(22) Filed: Jul. 9, 2012

Related U.S. Application Data
(60) Provisional application No. 61/505,901, filed on Jul. 8, 2011.

(51) Int. Cl. B67D 7/06; B67D 3/00; B67D 7/56

(52) U.S. Cl. 222/23; 222/155; 222/478; 222/159

(57) ABSTRACT

Apparatus for dispensing a flowable substance, e.g., a fluid, has a housing with an indicating chamber, an outlet and two fluid paths from a container, one of the fluid paths to the indicating chamber and the other fluid path to the outlet. The indicating chamber may have indicia identifying, in real time, an amount of fluid that has flowed through the outlet. A shroud-cap may close the outlet and obscure the indicating chamber. Each fluid path includes a respective metered inlet. All the metered inlets are substantially identical in size and shape. Some disclosed shapes reduce surface tension for more accurate readings. A snorkel tube may extend into a container to supply makeup air into the container as fluid is dispensed. An indicating spout for flexible containers is vented to only the exterior of the flexible container.

### CROSS REFERENCE TO RELATED APPLICATIONS

This application claims the benefit of U.S. Provisional Patent Application No. 61/505,901, filed Jul. 8, 2011, titled “Apparatus and Methods for Dispensing Fluid,” the entire contents of which are hereby incorporated by reference herein, for all purposes.

### TECHNICAL FIELD

The invention generally relates to fluid dispensers and, more particularly, to fluid dispensers that determine volumes of fluid dispensed from the fluid dispensers.

### BACKGROUND ART

Fluids, such as liquid laundry detergent, beverages, liquid fertilizer and the like, are often are sold to retail consumers in containers having removable caps. Accordingly, for example when washing a load of laundry, a person may remove a cap from a container and pour a measured amount of detergent into a washing machine.

A number of techniques may be used to measure a desired amount of detergent to use in a load of laundry. One method involves pouring the detergent into a graduated measuring cup. Although this method is simple, it often leaves some detergent in the measuring cup. As a result, this method both wastes some detergent and causes inaccurate amounts of detergent to be poured into the washing machine. In addition, soiling an additional component, i.e., the measuring cup, further complicates the overall laundering process.

In response to this problem of requiring separate measuring cups, some manufacturers add graduation indicia to their caps. These caps effectively become graduated measuring cups. However, despite the benefit of eliminating an extra component, this solution still suffers from many of the same problems that arise when using a separate graduated measuring cup. For example, the cap still may have residual amounts of detergent left in it after use, consequently causing both the above noted waste and inaccuracy problems. In fact, this solution has an additional problem, namely, when re-attaching the cap to the container, residual detergent left in the cap often spills onto an outside surface of the container or onto other nearby surfaces, e.g., a working surface or a base. Accordingly, although this solution eliminates the additional component problem, it adds an additional complication, and it still suffers from many of the same problems.

One class of prior art device has addressed these problems by integrating a measuring cavity having a predetermined volume in a combination cap/spout. The cavity is in fluid communication with the interior of the container. The cavity is configured, such that if a user tilts the container into a first (“fill”) orientation, fluid from the container fills the cavity. If the user then tilts the container into a second (“dispense”) orientation, the fluid from the cavity, but not additional fluid from the container, flows through the spout. Thus, the user can dispense the predetermined volume of fluid with each two-step manipulation of the container. This type of cap is commonly referred to as a “fill-and-dispense” type cap. Some examples of fill-and-dispense type caps are attached to liquor bottles and are used to disperse predetermined quantities (“shots”) of liquor. Another example of such a device is described in U.S. Pat. No. 4,666,065 to Tom H. Ohren.

Another prior art solution to the above-described problems is disclosed in U.S. Pat. No. 7,845,524 to Christopher T. Evans, et al., which is currently assigned to the assignee of the present application, and a copy of which is hereby incorporated by reference herein. Evans discloses a device for dispensing fluid from a container and for indicating a quantity of the fluid dispensed, as the fluid is being dispensed. In other words, the Evans device provides a real-time indication of the cumulative quantity of fluid that has been dispensed. In one embodiment, Evans's device includes a spout for dispensing fluid from inside a container. When the container is tilted into a dispensing orientation, fluid flows from the interior of the container, through a metered pour inlet, and then out through the spout.

The device also includes a visible indicating chamber in fluid communication with the interior of the container. The indicating chamber is not, however, open to outside the container. When the container is tilted into the dispensing orientation, fluid also flows from the interior of the container, through a metered indicating inlet, into the indicating chamber and is captured in the indicating chamber. Thus, as fluid is dispensed through the spout, the indicating chamber progressively fills with fluid. The metered pour inlet and the metered indicating inlet are sized proportionally, such that the indicating chamber fills at a rate that is related to the rate at which fluid

is dispersed through the spout. The indicating chamber may be graduated to facilitate dispersing desired quantities.

However, some users find the Evans device confusing or not intuitive. For example, some users mistake the Evans device for a fill-and-dispense type cap. These users may attempt to fill the indicating chamber before dispensing any fluid. These users may not position the spout over a desired receiving vessel, such as a washing machine, while attempting to fill the indicating chamber. These users may, therefore, be unpleasantly surprised to find fluid unexpectedly flowing from the spout. Although directions for proper use may be printed on the container, many users ignore or do not read directions.

Thus, although the Evans device provides a clever way to measure fluid as it is being dispersed from a container, it creates several problems, including the above-described user confusion.

### SUMMARY OF EMBODIMENTS

An embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The system includes a cap configured to selectively toggle between a first orientation and a second orientation. In the first orientation, the cap closes the outlet and obscures the indicating chamber from view by a user. In the second orientation, the cap opens the outlet and reveals the indicating chamber for view by the user.

Another embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The metered pour inlet defines at least one metered inlet aperture and the metered indicating inlet defines at least one metered indicating aperture. All the metered inlet apertures and the metered indicating apertures having substantially identical sizes and shapes.

Optionally, the shapes of the metered inlet apertures and the shapes of the metered indicating apertures may be sinuated shapes. For example, the metered inlet apertures and the metered indicating apertures may be star shaped.

For each metered indicating aperture, the metered indicating inlet may include a wall extending from a plane of the metered indicating aperture and surrounding the metered indicating aperture. An edge of the wall may define a plurality of shapes. Each shape may be sharp, rounded or irregular.

Yet another embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The system includes a snorkel tube. One end of the snorkel tube is in fluid communication with the indicating chamber. The other end of the snorkel tube is configured to extend into the container.

Optionally, snorkel tube is configured to have a length to inside diameter ratio of about 7.76:1.

Another embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The housing defines at least one vent hole along a vent path. One end of the vent path is in fluid communication with an interior of the container. The other end of the vent path is in fluid communication with an exterior of the container. The metered pour inlet and the vent hole are substantially coplanar; there is no snorkel tube. The housing is configured such that, when the apparatus is oriented at an expected dispensing angle, the vent hole(s) is(are) higher than the metered pour inlet.

An embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The first fluid path and the second fluid path are configured such that, in use, the indicating chamber begins to visibly fill with fluid at substantially the same time as fluid begins to exit the outlet, within perception limits of a human user.

Another embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The metered pour inlet and the metered indicating inlet are configured such that, in use, an expected quantity of the fluid exits the outlet in no less than about 0.5 seconds and no more than about 30 seconds.

Yet another embodiment of the present invention provides a fluid dispensing system for dispensing fluid from an interior of a container. The system indicates, in real time, a quantity of the fluid that has, thus far, been dispensed through the apparatus in a single pour. The system includes an outlet, an indicating chamber and a housing. The housing defines two fluid paths from the interior of the container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet. The indicating chamber has a longitudinal axis. The indicating chamber is configured such that, when the fluid dispensing system is oriented at an expected dispensing angle, the longitudinal axis of the indicating chamber is substantially vertical.

An embodiment of the present invention provides a fluid dispensing system for dispensing fluid from an interior of a flexible container. The system indicates, in real time, a quantity of the fluid that has, thus far, been dispensed through the apparatus in a single pour. The system includes an outlet, an indicating chamber vented to only an exterior of the flexible container and a housing. The housing defines two fluid paths from the interior of the flexible container. The first fluid path extends, via a metered pour inlet, to the outlet, and the second fluid path extends, via a metered indicating inlet, to the indicating chamber. The metered indicating inlet and the metered pour inlet are sized such that a rate at which the fluid flows through the indicating inlet is related to a rate at which the fluid flows through the outlet. The metered indicating inlet and the metered pour inlet are further sized such that a quantity of fluid received into the indicating chamber relates in real time to a quantity of fluid that has thus far exited through the outlet.

Optionally, the flexible container is not vented to an exterior of the flexible container.

### BRIEF DESCRIPTION OF THE DRAWINGS

The invention will be more fully understood by referring to the following Detailed Description of Specific Embodiments in conjunction with the Drawings, of which:

FIG. 1 schematically shows a perspective view of a fluid dispensing system, according to the prior art.

FIG. 2 schematically shows a perspective, partially cut away view of a spout shown in FIG. 1.

FIG. 3 schematically shows the fluid dispensing system of FIG. 1 while pouring fluid through its outlet.

FIG. 4 shows a cross-sectional view of a portion of the fluid dispensing system shown in FIG. 1 in a rest position, including a cross-sectional view across an inlet to an indicating chamber.

FIG. 5 shows a cross-sectional view of another portion of the fluid dispensing system shown in FIG. 1 in a rest position, including a cross-sectional view across an inlet to a pour chamber.

FIG. 6 shows the cross-sectional view of FIG. 4 while pouring fluid through its spout.

FIG. 7 shows the cross-sectional view of FIG. 5 while pouring fluid through its spout.

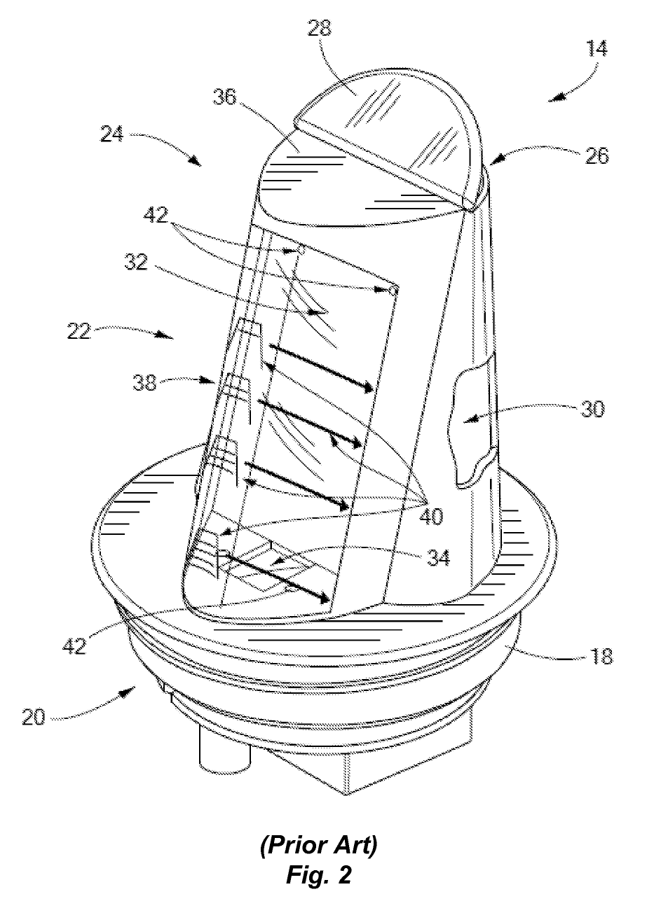

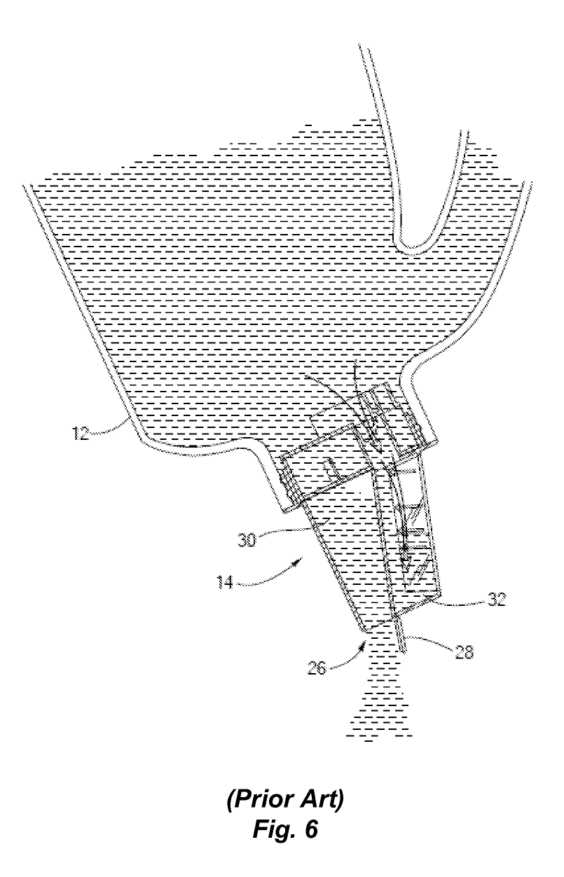

FIG. 6 schematically shows an exploded view of the spout shown in FIG. 2.

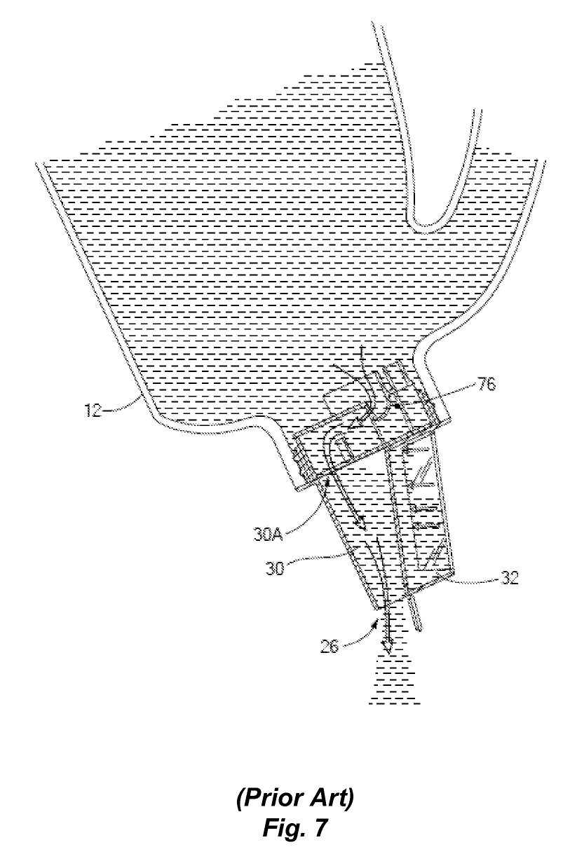

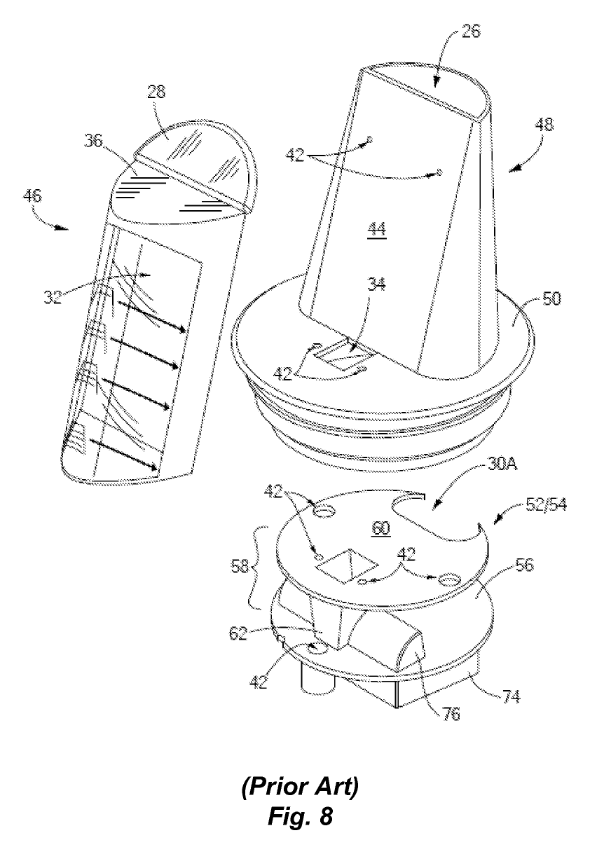

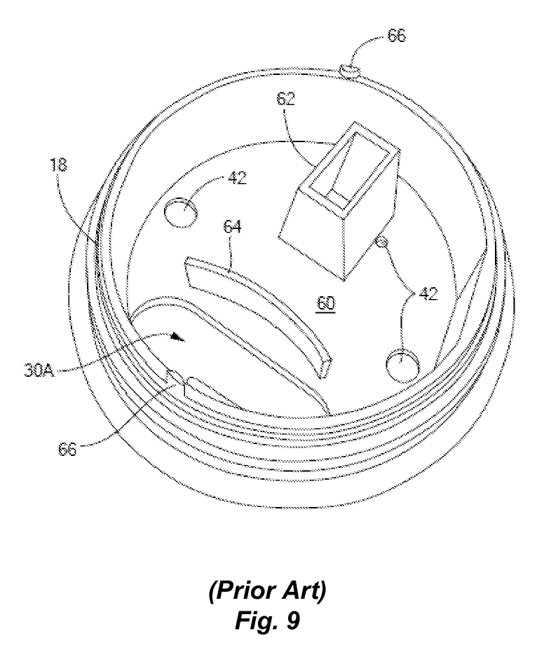

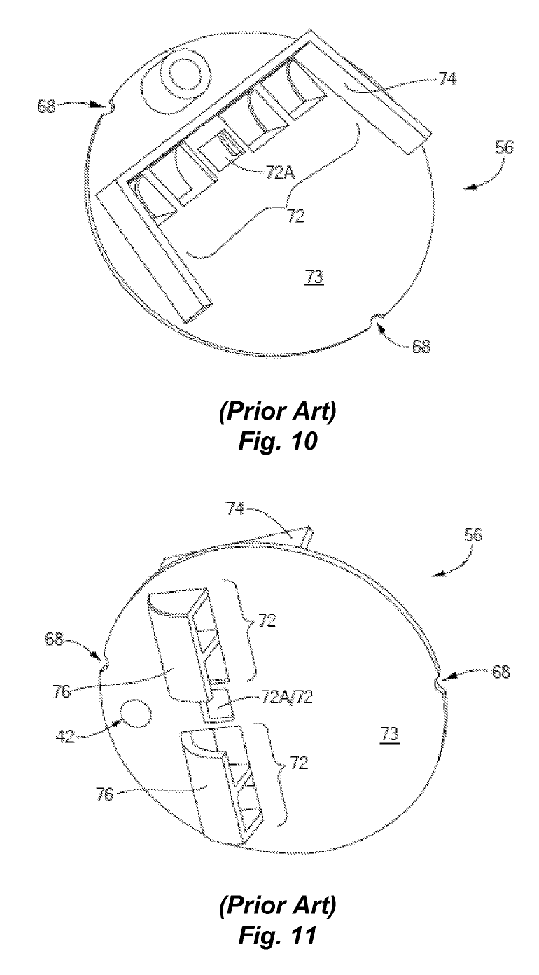

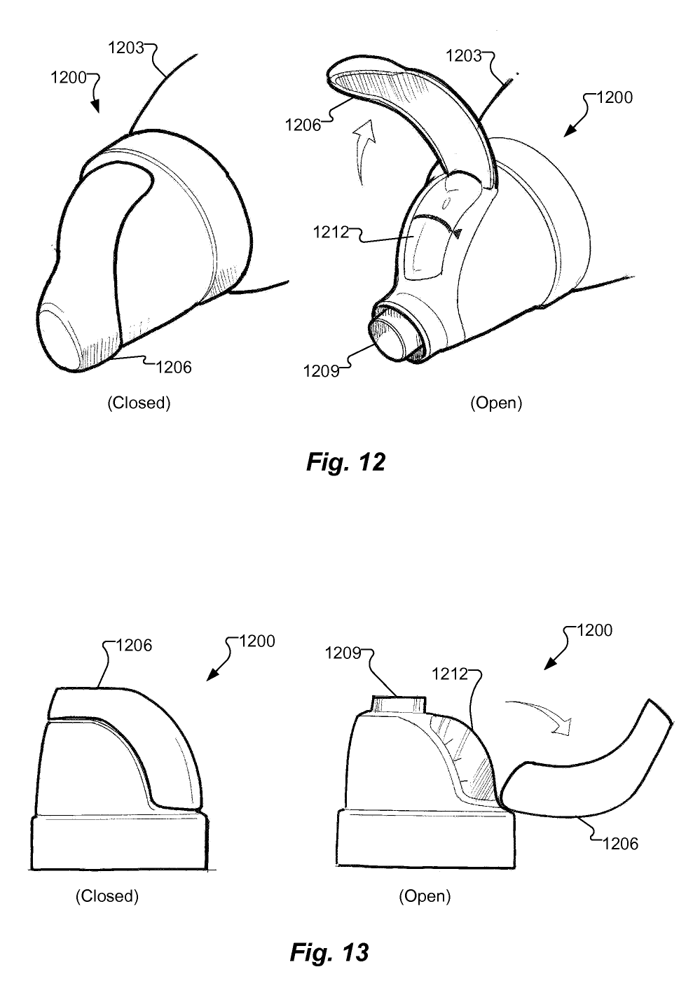

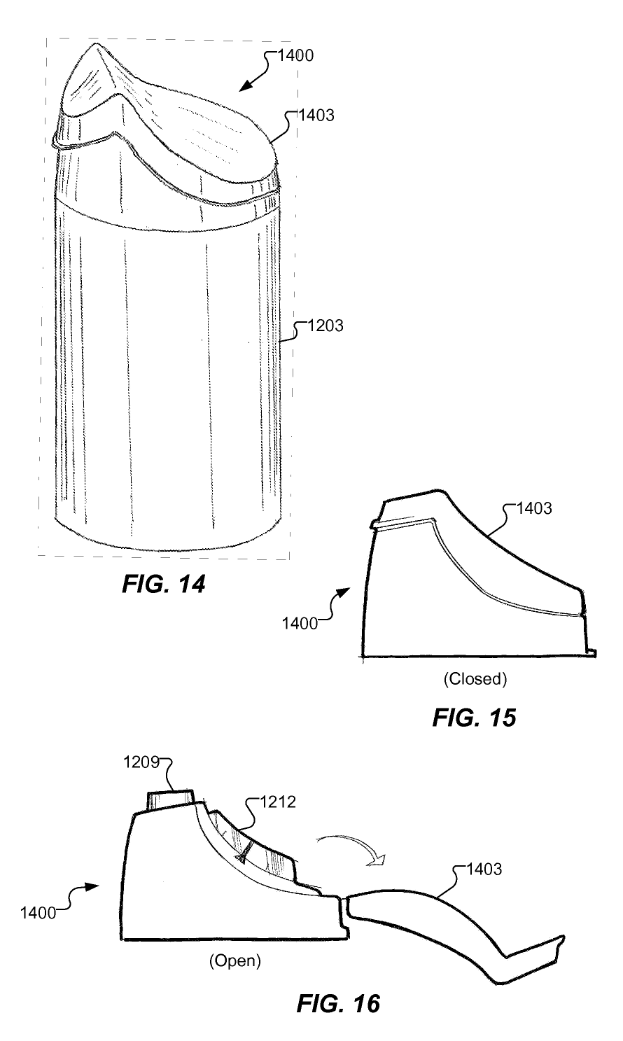

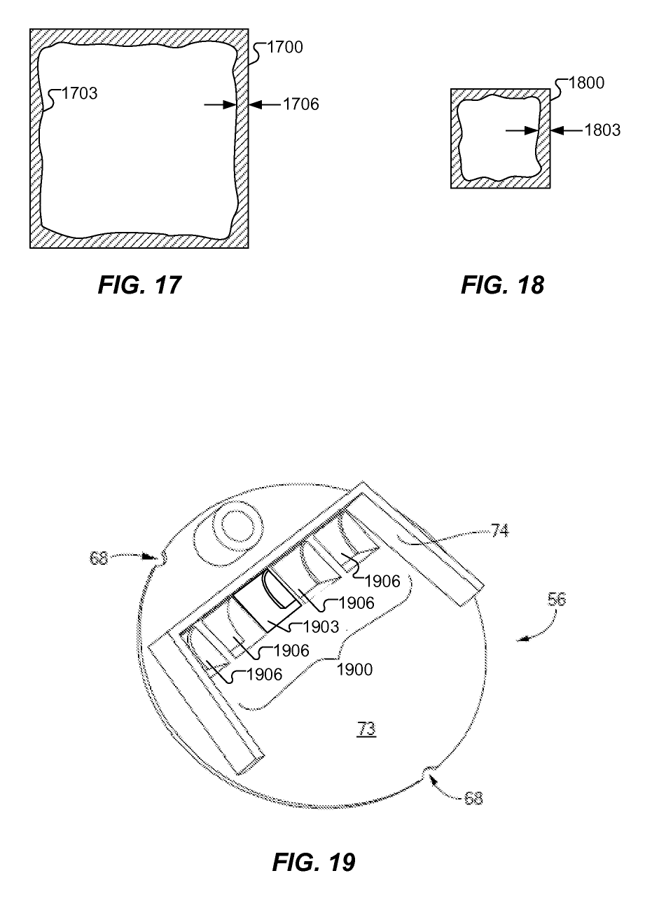

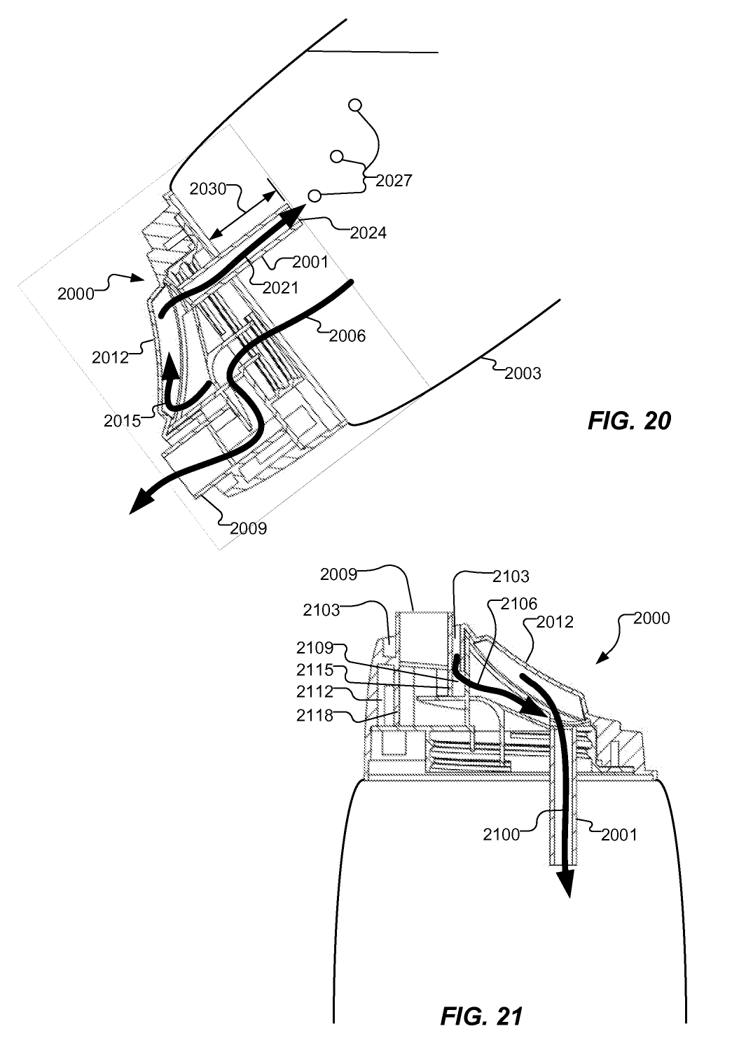

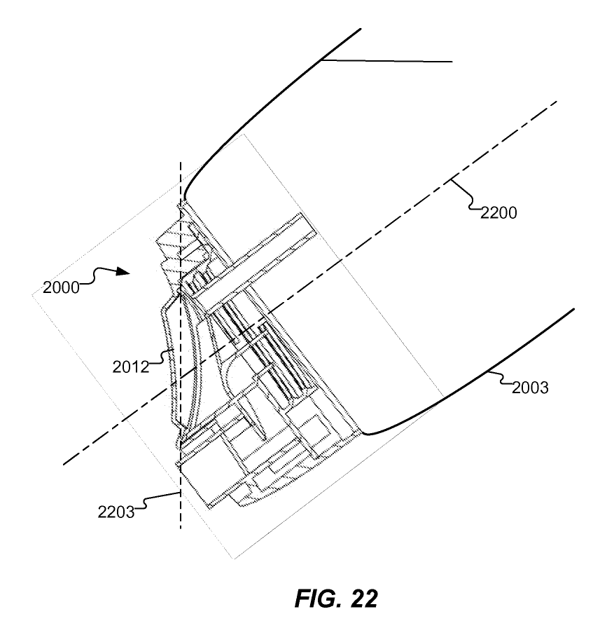

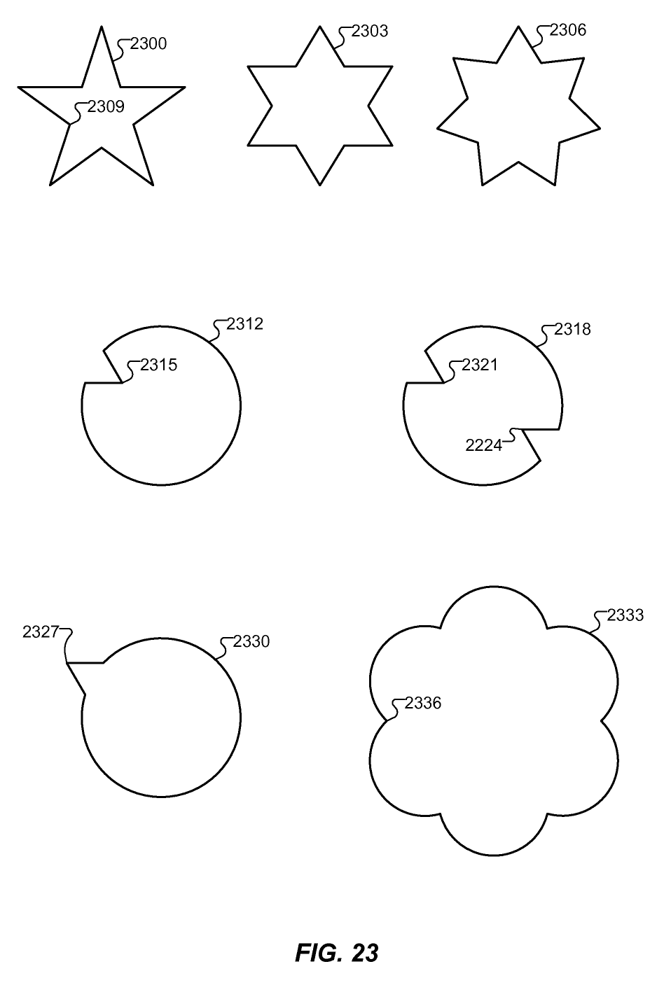

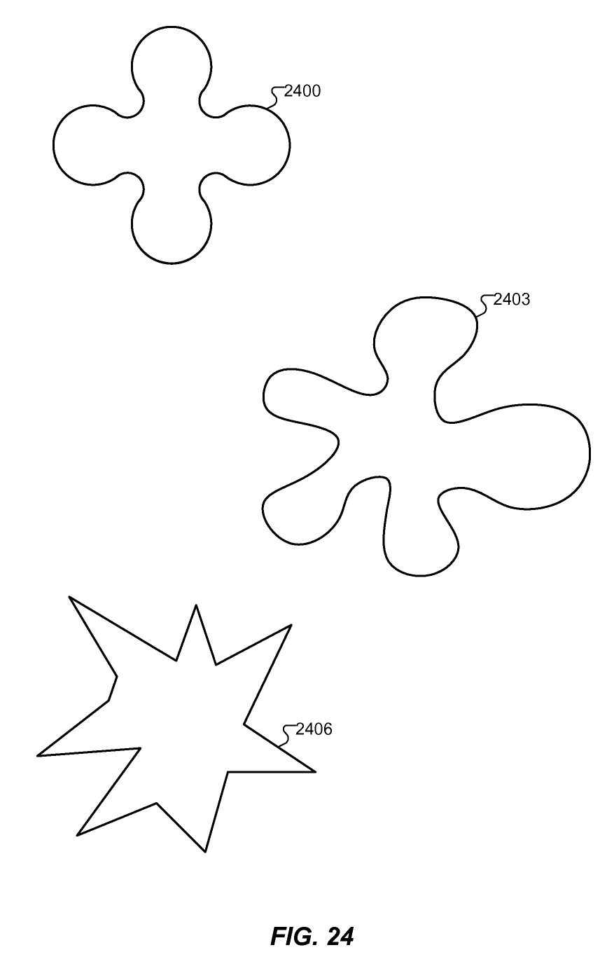

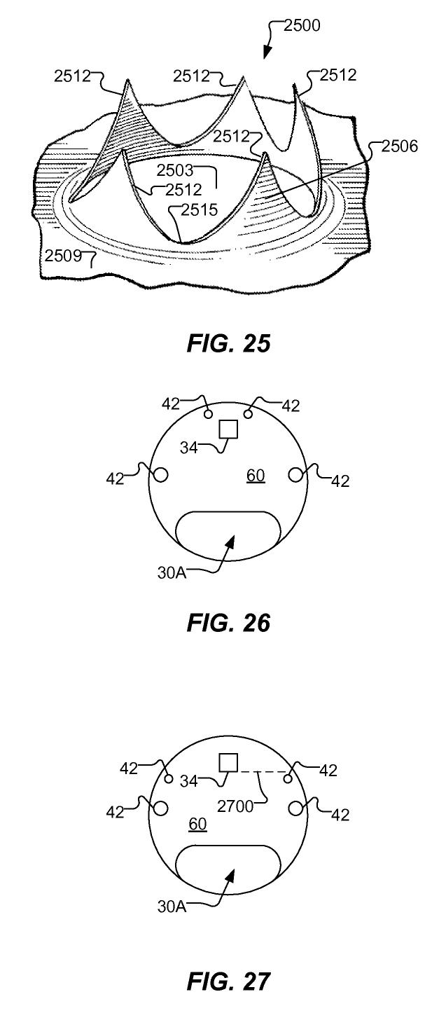

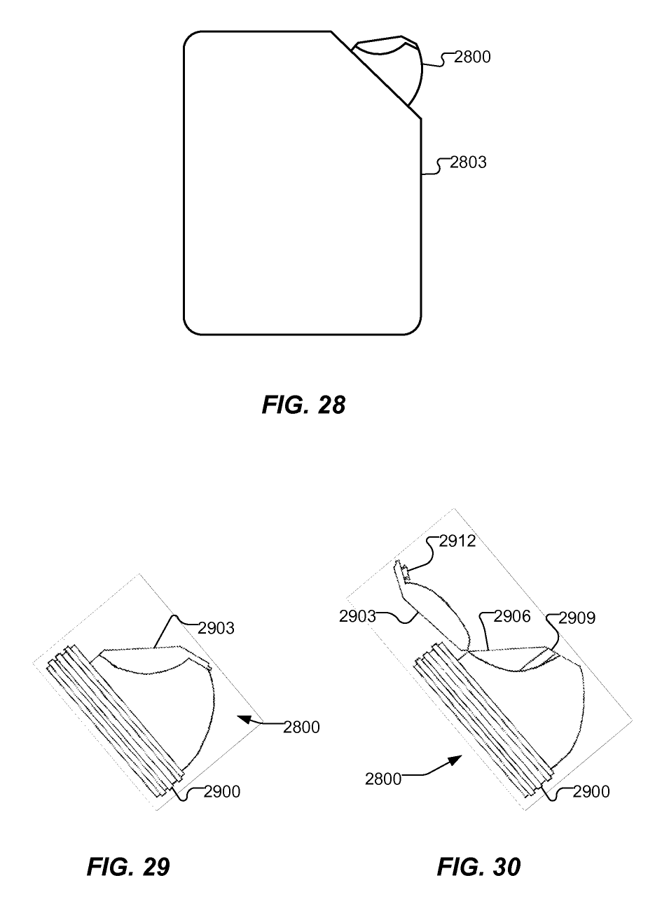

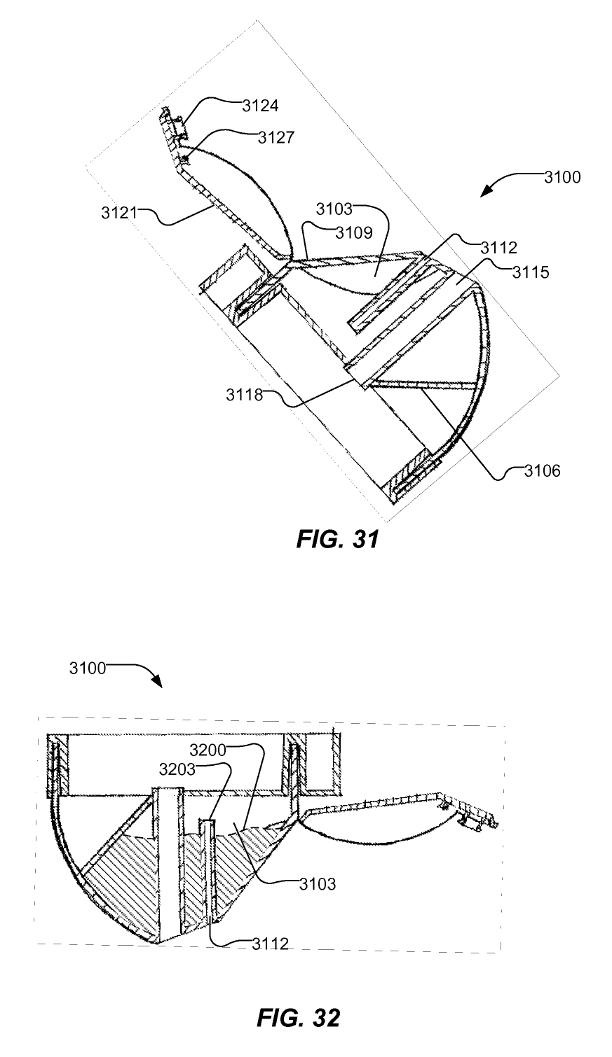

FIG. 7 schematically shows a bottom view of the spout shown in FIG. 2 with its covering lid removed.

FIGS. 10 and 11 schematically show interior and exterior sides, respectively, of a covering lid, which is part of the spout shown in FIG. 2.

FIG. 12 is a perspective illustration of a shroud-capped fluid dispensing system, showing both closed and open configurations, according to an embodiment of the present invention.

FIG. 13 is a side view illustration of the shroud-capped fluid dispensing system of FIG. 12.

FIG. 14 is a perspective illustration of a shroud-capped fluid dispensing system, according to another embodiment of the present invention.

FIGS. 15 and 16 are side views of the shroud-capped fluid dispensing system of FIG. 14, showing close and open orientations, respectively.

FIGS. 17 and 18 are schematic diagrams of hypothetical fluid openings of fluid dispensing systems, according to an embodiment of the present invention.

FIG. 19 is a perspective illustration of an interior side of an exemplary covering lid that has equal sized fluid openings, according to an embodiment of the present invention.

FIGS. 20 and 21 are cross-sectional views of a fluid dispensing system that includes a snorkel tube, according to an embodiment of the present invention.

FIG. 22 is a cross-sectional view of a fluid dispensing system, showing an angle at which an indicating chamber may be oriented, relative to a remainder of the fluid dispensing system, according to an embodiment of the present invention.

FIGS. 23, 24 and 25 schematically illustrate several exemplary shapes of fluid openings, according to several embodiments of the present invention.

FIG. 26 schematically illustrates placement of vent holes, relative to a pour inlet, according to an embodiment of the present invention.

FIG. 27 schematically illustrates placement of the vent holes, according to another embodiment of the present invention.

FIG. 28 is a side view schematic diagram of a flexible container with an indicating spout, according to an embodiment of the present invention.

FIGS. 29 and 30 are more detailed views of the spout of FIG. 28.

FIGS. 31 and 32 are cross-sectional schematic views of a spout, similar to the spout of FIGS. 29 and 30, according to another embodiment of the present invention.

### DETAILED DESCRIPTION OF SPECIFIC EMBODIMENTS

In accordance with embodiments of the present invention, methods and apparatus are disclosed for a fluid dispensing spout that identifies, in real time, the approximate cumulative amount of fluid passing through it during a single pour. For example, if it is part of a laundry detergent container, the spout may identify the approximate amount of detergent poured into a washing machine at a given time. Accordingly, a user does not need to use a measuring cup or other apparatus to ensure that the proper amount of detergent has been dispensed. To that end, the spout may be considered to sample a portion of fluid entering it, and to identify and indicate substantially the total volume of fluid having passed through its outlet, as a function of the sampled fluid.

Embodiments of the present invention include a housing with an indicating chamber, an outlet and two fluid paths from a container. One of the fluid paths extends to the indicating chamber, and the other fluid path extends to the outlet. The indicating chamber may have indicia identifying, in real time, an amount of fluid that has flowed through the outlet. A shroud-cap may close the outlet and obscure the indicating chamber. Each fluid path includes a respective metered inlet. All the metered inlets may be substantially identical in size and shape. Various shapes reduces surface tension at the metered inlets and, therefore, provide more accurate volumetric measurements. A snorkel tube may extend into a container to supply makeup air into the container as fluid is dispensed. The snorkel tube may also drain fluid from the indicating chamber, after the apparatus is returned to a rest orientation. Alternatively, the housing may define at least one vent hole along a vent path, one end of the vent path being in fluid communication with an interior of the container, the other end of the vent path being in fluid communication with an exterior of the container. In this case, the metered pour inlet and the vent hole may be substantially coplanar, an no snorkel may be included. When the apparatus is oriented at an expected dispensing angle, the vent hole(s) is(are) higher than the metered pour inlet. The two fluid paths may be configured such that, in use, the indicating chamber begins to visibly fill with fluid at substantially the same time as fluid begins to exit the outlet, within perception limits of a human user. The metered inlets may be configured such that, in use, an expected quantity of the fluid exits the outlet in a reasonable amount of time to allow a human user to suspend or cease dispensing the fluid before an expected volume of the fluid has been dispensed. In an embodiment intended for use with a flexible container, the indicating chamber may be vented to only an exterior of the flexible container.

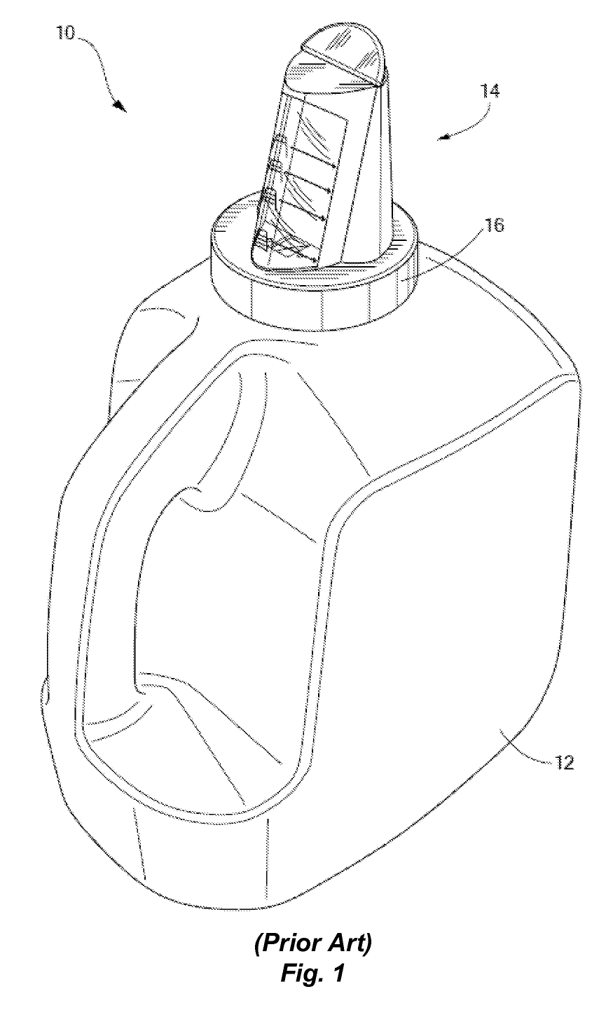

FIG. 1 schematically shows a perspective view of a fluid dispensing system 10, according to the prior art. More specifically, the fluid dispensing system 10 shown in FIG. 1 includes a laundry detergent container 12 for containing laundry detergent, and a spout 14 that dynamically identifies, in real time, the cumulative amount of fluid passing through it during a single pour. (The discussion here and elsewhere of liquid laundry detergent dispensing is for illustrative purposes only and is not meant to limit the present invention in any way. As noted, other liquid and non-liquid fluids may be dispensed with appropriate embodiments.)

In a manner similar to conventional laundry detergent containers, the container 12 may be formed from injection molded or blow-molded plastic and have an integrated handle to facilitate use. Moreover, the spout 14 may connect to the container 12 in a wide variety of ways. For example, the spout 14 may be integrated into the neck 16 of the container 12, or adhered to the container 12 by an adhesive or by a conventional ultrasonic welding process.

Alternatively, the spout 14 may be removably connected to the container 12. Among other configurations, the spout 14 may have threads 18 (see FIG. 2) that engage a mating portion of the container 12. Of course, those skilled in the art should understand that a variety of conventional means may be used to removably or non-removably connect the spout 14 to the container 12. In addition, although shown at the top of the container 12, the spout 14 may connect with the container 12 at any other reasonable location. For example, the spout 14 may be connected to the side of the container 12, or even to what appears to be the bottom of the container 12 (e.g., via a specially molded container 12 that permits the nozzle to be mounted in such a manner). Valving devices (not shown) also may be used to more carefully control fluid flow.

It should be noted that discussion of a laundry detergent container 12, laundry detergent and a laundry detergent system is presented for illustrative purposes only and not intended to limit the scope of any embodiments of the invention. In fact, various embodiments can be implemented with a wide variety of containers containing many different types of fluids. Moreover, discussion of liquids, such as liquid laundry detergent, also is for illustrative purposes and not intended to limit the scope of any embodiments of the invention. For example, some embodiments may dynamically measure volumes of motor oil flowing through the spout 14. In fact, fluids flowing through the spout 14 may include any suitable liquids, such as liquid laundry detergent, or powders, such as laundry detergent or bleach in powder form, beverages or beverage concentrates, cleaning fluids, etc.

FIG. 2 shows a partially cut away, perspective view of the spout 14 shown in FIG. 1. In particular, the spout 14 has a bottom portion 20 that screws onto the neck 16 of the container 12, a main body 22 for both identifying fluid volumes and permitting fluid to flow therethrough, and a top portion 24 that forms a fluid outlet 26. All portions 20, 22 and 24 illustratively are formed from plastic by conventional injection molding processes, although any suitable material and fabrication process may be used.

The top portion 24 also includes a cap 28 formed as a living hinge that provides a snap-fit closure for the fluid outlet 26. Accordingly, prior to pouring fluid through the spout 14, a user pivots the cap 28 rearwardly to open the fluid outlet 26. In a corresponding manner, after pouring fluid through the spout 14, the user may pivot the cap 28 back toward the fluid outlet 26 to prevent inadvertent fluid leakage.

To permit fluid flow through the spout 14 and measure fluid volumes substantially simultaneously, the main body 22 respectively has a pour chamber 30 that channels fluid to the outlet 26, and an indicating chamber 32 for identifying a cumulative amount of fluid that has passed through the outlet 26 during a single pour. In illustrative embodiments, the indicating chamber 32 has an indicating inlet 34 at its bottom end for receiving a sample amount of fluid, and a closed opposite end 36. Accordingly, the indicating inlet 34 is the only port for permitting fluid in or out of the indicating chamber 32. The indicating inlet 34 thus acts as a fluid outlet in certain instances, e.g., when the spout 14 is turned upright after pouring fluid through the pour chamber 30. In addition, the indicating chamber 32 has a transparent or translucent side wall 38 with visual indicia 40 identifying the approximate cumulative volume of fluid that has flowed through the fluid outlet 26.

As shown, the indicia 40 may be horizontal graduations with optional identifying symbols. The indicia 40 nevertheless can include a number of other means, including different visual markings, movable parts and/or audible signals. Details of illustrative movable parts are shown in abandoned U.S. patent application Ser. No. 11/199,578, filed on Aug. 8, 2005 and entitled, “Apparatus and Method of Dispensing Fluid,” the contents of which are hereby incorporated herein. Audible signals can be implemented in a number of manners. For example, a microchip (not shown) may be configured both to detect fluid volumes and emit a beep for every ounce of fluid it detects. Such a microchip may be positioned in the indicating chamber 32. In some embodiments, however, the indicating chamber 32 may be eliminated by positioning the microchip within the pour chamber 30. As another example, venting could be tuned to provide audible signals indicating fluid volumes being poured.

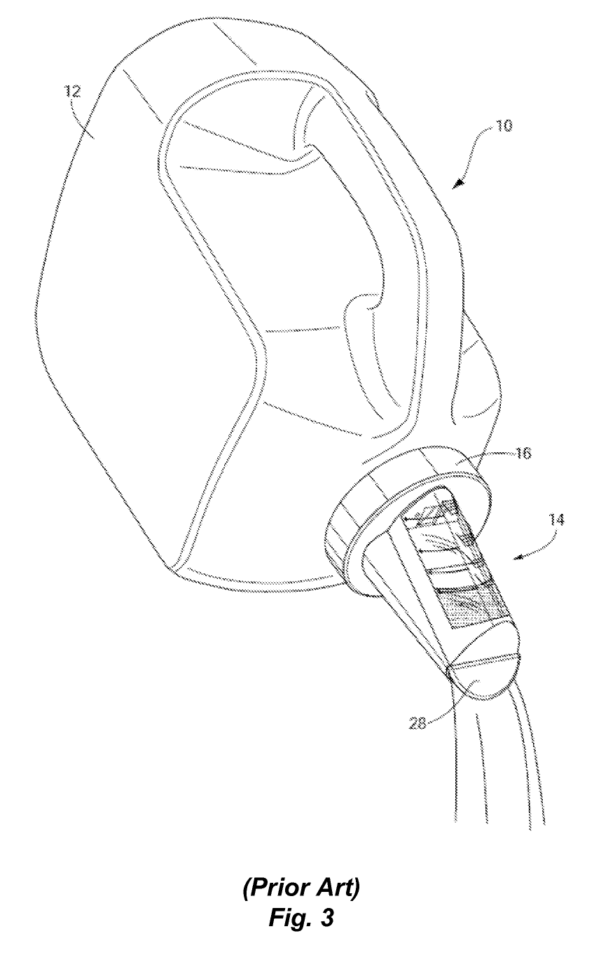

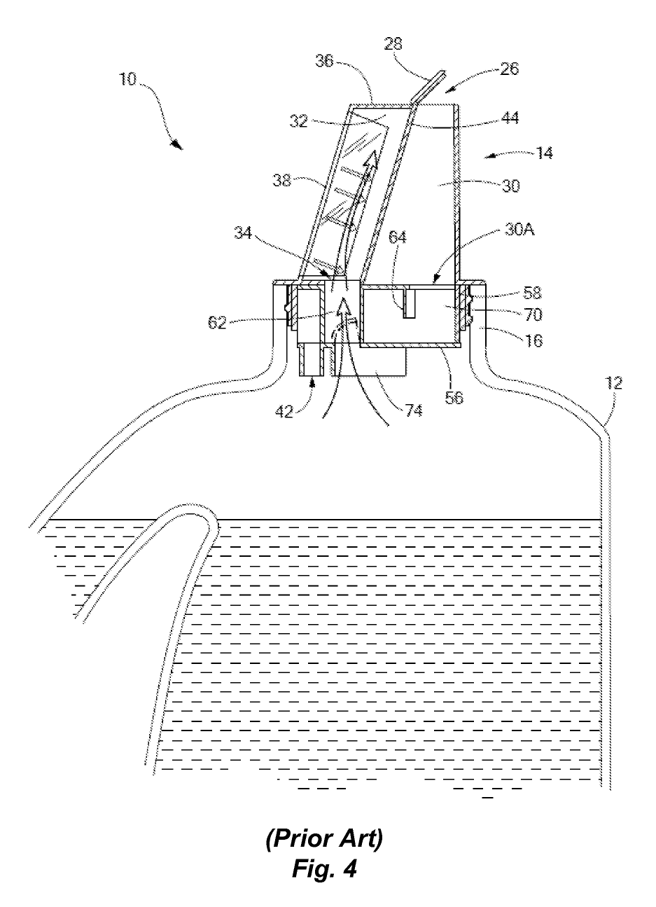

When pouring, i.e., when the outlet 26 is tipped so that it faces at some angle downwardly relative to horizontal, as shown in FIG. 3, gravity or some other force or pressure forces fluid through the pour chamber 30 and, ultimately, through the outlet 26. Fluid enters the pour chamber 30 via a pour inlet 30A (FIG. 4). At the same time, fluid enters the indicating chamber 32 via the indicating inlet 34 and pools at the closed opposite end 36 of the indicating chamber 32. The fluid level in the indicating chamber 32 progressively rises to show the total amount of fluid that has passed through the outlet 26.

By way of example, from the inverted position, i.e., when pouring, the bottom graduation, i.e., the graduation nearest the closed end 36 of the indicating chamber 32, may represent about a quarter cup of fluid (having flowed through the outlet 26), the next graduation may indicate about a half cup of fluid, the third graduation may indicate about three quarters of a cup of fluid, and the final graduation, i.e., nearest the indicating inlet 34, may indicate about a full cup. Accordingly, as discussed below, fluid is metered through the pour chamber 30 and the indicating chamber 32 in a manner that ensures the general accuracy of these readings. Of course, fluid flow may be controlled to provide graduations identifying any practical, desired level. For example, the sizes of the pour inlet 30A and the indicating inlet 34, as well as the interior geometry of the chambers, may be changed to increase or decrease fluid flow rates. The graduations discussed above therefore are exemplary and not intended to limit various aspects of the invention.

As shown in FIG. 2, among others, the indicating chamber 32 also has vent holes 42 to facilitate air flow into and out of its interior. In illustrative embodiments, the vent holes 42 are substantially smaller than the indicating inlet 34. The material forming the vent holes 42 illustratively has hydrophobic qualities that, together with the small size of the vent holes 42, mitigate the likelihood of fluid flowing therethrough. The size of the vent holes 42 nevertheless are coordinated with the size of the indicating inlet 34, housing material, and anticipated flow properties of the fluid, e.g., surface tension and viscosity, to ensure appropriate fluid flow rates into and from the indicating chamber 32. The spout 14 has additional vents, discussed below, which have similar properties relative to other discussed ports.

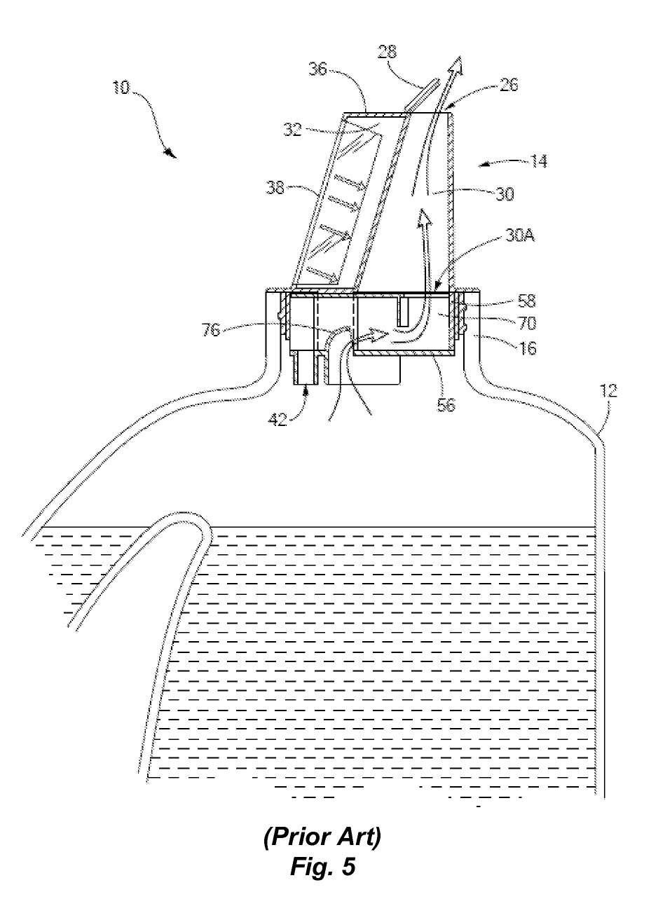

FIGS. 4 and 5 schematically show cross-sectional views of the system 10 shown in FIG. 1 when upright, i.e., not pouring fluid. Specifically, FIG. 4 shows a cross-sectional view through the indicating inlet 34, while FIG. 5 shows a cross-sectional view through a fluid path leading to the pour inlet 30A. FIGS. 4 and 5 also have flow arrows showing the directions that fluid should flow when the system 10 is tilted for pouring fluid. In particular, the flow arrows in FIG. 4 show the path that fluid should take into the indicating chamber 32, while the flow arrows in FIG. 5 show the path that fluid should take through the pour chamber 30. Of course, when in the upright position, fluid does not follow the flow arrows, which are included simply for illustrative purposes. FIGS. 4 and 5 clearly show a number of the internal components, including the pour chamber 30, indicating chamber 32, and a dividing wall 44 between the two chambers. Details of these and other structures are discussed below, with respect to FIGS. 6, 7, 10, and 11.

FIGS. 6 and 7, respectively, show the views of FIGS. 4 and 5 while pouring fluid (corresponding to FIG. 3). As shown in FIGS. 6 and 7, fluid follows the paths delineated by the flow arrows of FIGS. 4 and 5.

The spout 14 may be produced in accordance with conventional processes. For example, as shown in FIG. 8, the spout 14 may be formed by coupled first, second, and third separately moldable pieces. In particular, as shown in FIG. 8, the first piece 46 has the indicating chamber 32 and cap 28, while the second piece 48 has the pour chamber 30 extending upwardly from a base portion 50, and threads 18 extending downwardly from the base portion 50. The third piece 52 has a flow control apparatus 54, which includes a vented lid 56 and a fluid handler 58 for directing fluid within the spout 14. The three pieces 46, 48, and 52 may be coupled in a conventional manner, such as by one or more of an adhesive or ultrasonic welding process. In some embodiments, the threads 18 may be formed as part of the third piece 52, rather than as part of the second piece 48.

FIGS. 9, 10, and 11 show additional details of the third piece 52. In particular, FIG. 9 shows a bottom view of the fluid handler 58 uncoupled from the vented lid 56 (shown in FIGS. 10 and 11). The embodiment shown in FIG. 9 also includes the threads 18. The fluid handler 58 includes a number of integral components that cooperate with the vented lid 56 to direct fluid either to the indicating chamber 32 or the pour chamber 30 in a controlled manner. Specifically, the fluid handler 58 includes a flat surface 60 forming an inlet channel 62 leading to the indicating chamber 32, and the above discussed pour inlet 30A.

To ensure that fluid enters the pour inlet 30A in a controlled manner, the fluid handler 58 also includes a fluid redirector 64 extending from the flat surface 60. The fluid handler 58 illustratively is a large diameter, curved, concave wall from the perspective of the pour inlet 30A. Accordingly, when the system 10 is in a pouring mode, the convex surface of the fluid redirector 64 reduces the speed at which a fluid enters the pour inlet 30A. Consequently, fluid flow through the spout 14 should be smooth and controlled.

The fluid handler 58 also includes vent holes 42 for the indicating chamber 32 and the pour chamber 30, as well as positioners 66 that facilitate attachment of the vented lid 56 to the fluid handler 58. The vented lid 56 therefore has indents 68 along its rim (see FIGS. 10 and 11, discussed below) corresponding to the locations of the positioners 66.

FIGS. 10 and 11, respectively, show exterior and interior views of the vented lid 56. When assembled, the interior side of the vented lid 56 and fluid handler 58 are considered to form an interior chamber 70 (see FIG. 4) that leads to the pour inlet 30A of the pour chamber 30. Accordingly, as shown in FIG. 10, the vented lid 56 may be considered to have a base 73 with five aligned fluid openings 72, and a vent hole 42 for venting the interior chamber 70. The center fluid opening (shown as 72A) is in intimate contact with and leads directly to the inlet channel 62 of the fluid handler 58, i.e., leading to the indicating chamber 32, while the other openings generally lead to the interior chamber 70. During use, fluid flows from the exterior of the vented lid 56, i.e., from the container 12, through the five fluid openings 72, and into either the indicating chamber 32 or the interior chamber 70, depending on which of the openings 72 is being considered. Fluid in the interior chamber 70 ultimately leads to the pour inlet 30A.

The vented lid 56 also includes a flange 74 extending partially about the five fluid openings 72. For example, as shown in FIG. 10, the flange 74 extends approximately around three sides of the fluid openings 72. The flange 74 has a number of benefits, including having the effect of pooling fluid in the area of the fluid openings 72. By pooling fluid in this manner, fluid should flow through the outlet 26 in a continuous manner.

FIG. 11 shows the interior side of the vented lid 56, which includes a pair of fluid guides 76 that extend inwardly of the base 73. In illustrative embodiments, each fluid guide 76 has a concave interior surface that redirects incoming fluid from the fluid openings 72 into the interior chamber 70 in a direction that is not substantially normal to the surface of the base 73. Stated another way, fluid exiting the terminal end of one of the fluid guides 76 should not be traveling in a direction that is normal to the base 73. Of course, it is expected that fluid may be traveling substantially normal to the base 73 shortly after it exits the fluid guides 76. Among other benefits, the fluid guides 76 should have the effect of decreasing fluid flow rates, thus providing a smoother and more constant flow of fluid through the spout 14 in many anticipated instances, as compared to spouts that do not include these features.

The size, number, and geometry of the various discussed vented lid components are carefully controlled to ensure prespecified flow rates through the spout 14. For example, the vented lid 56 could have smaller fluid openings 72 or fewer fluid openings 72 to provide slower fluid flow rates through the spout 14. Accordingly, discussion of specific geometries and numbers, such as five substantially rectangular fluid openings 72, or the geometry of the flange 74, is for illustrative purposes only.

To dispense fluid, a user therefore may tilt the container 12 to an angle that causes fluid to pass through the spout 14 (see FIG. 3). The user may continue to pour the fluid until the indicating chamber 32 shows that a desired amount of fluid has been dispensed. At that point, the user may orient the system 10 in an upright manner (see FIG. 1) for storage. The user therefore does not need additional cups to measure the fluid. In addition, the user also does not need to remove the spout 14 from the container 12. Instead, the user simply pours fluid in one step.

Accordingly, the indicating chamber 32 may be considered to “sample” a portion of fluid flowing into the spout 14. Because of the geometry and makeup of the spout 14, this portion of fluid should be substantially proportional to the amount of fluid that has thus far flowed through the spout outlet 26. This portion of fluid entering the spout 14 thus cooperates with the visual indicia 40 to show approximate fluid volumes the system 10 dispenses. Moreover, different spout geometries can be used for different types of fluids having different flow characteristics. Empirical testing should suffice to pre-determine the proportion of sampled fluid in the indicating chamber 32.

In a manner similar to many other fluid measurement devices, fluid readings provided by the device may include a small error. Accordingly, fluid readings should be considered an approximation and not necessarily an exact amount. For example, a reading of 0.5 cups could indicate that the spout 14 dispensed about 10% more to about 10% less than 0.5 cups of fluid. Testing has determined that fluid readings often are less accurate when the container 12 is almost empty or completely full. In controlled laboratory conditions, accuracy is enhanced, therefore mitigating the error factor. It nevertheless is anticipated that during use, human error will contribute to the error factor.

### Shroud-Cap

As noted, some users find the fluid dispensing system 10, discussed above with respect to FIGS. 1-11, to be confusing or not intuitive. We have found that hiding the indicating chamber 32 from view (“obscuring” the indicating chamber 32) until the cap 28 on the fluid outlet 26 is opened increases the likelihood that the fluid dispensing system will be operated in a proper sequence.

FIGS. 12 and 13 illustrate a shroud-capped fluid dispensing system 1200, according to an embodiment of the present invention, in both open and closed configurations. The shroud-capped fluid dispensing system 1200 is shown attached to a container 1203 (partially visible) in FIG. 12. A shroud-cap 1206 is attached to the remainder of the system 1200, such as by a live hinge, pin hinge, flexible member or another suitable connector. In a closed position (shown on the left sides of FIGS. 12 and 13), the shroud-cap 1206 snaps into place over an outlet 1209 and forms a fluid-tight closure over with the outlet 1209 (“closes the outlet”), thereby preventing inadvertently dispensing fluid. In the closed position, the shroud-cap 1206 also obscures an indicator 1212, which is constructed and operates along the lines described above, with respect to FIGS. 1-11. However, in the open position (shown on the right sides of FIGS. 12 and 13), the shroud-cap 1206 opens the outlet 1209, thereby enabling fluid to be dispensed from the container 1203. In addition, in the open position, the shroud-cap 1206 makes the indicator 1212 visible to a user.

In the closed position, the shroud-cap 1206 shown in FIGS. 12-13 covers a portion of the top of the fluid dispensing system 1200. That is, in a top-down view (not shown), portions of the fluid dispensing system 1200, other than the shroud-cap 1206, may be visible. FIGS. 14-16 illustrate another embodiment of a fluid dispensing system 1400, according to the present invention. This embodiment includes a shroud-cap 1403 that covers substantially the entire top surface of the fluid dispensing system 1400. In other respects, the embodiment shown in FIGS. 14-16 is similar to the embodiment described above, with reference to FIGS. 12-13.

In other embodiments (not shown), the shroud-cap may be completely detachable from, and re-attachable to, the remainder of the fluid dispensing system. In one such embodiment, the shroud-cap and the container are threaded, so the shroud-cap may be unscrewed from the container to both open the outlet and reveal the indicator. Similarly, the shroud-cap may be screwed onto the container to both close the outlet and obscure the indicator. In yet other embodiments (not shown), the shroud-cap may be implemented by a sliding gate that selectively opens and closes the outlet 1209. The sliding gate may obscure the indicating chamber 1212 while the gate is in the closed position, and the gate may define an aperture, through which the indicating chamber 1212 may be viewed while the gate is in the open position.

### Dosing Port Size

We have found that the configurations of the pour inlets 30A and the indicating inlets 34 (FIGS. 4 and 5) and, in particular, the configurations of the fluid openings 72 (FIGS. 10-11) (also referred to herein as “dosing ports”), are important to accuracy of the indicated dispensed fluid volume. For example, if the ratio of the rate at which fluid flows through the spout outlet and the rate at which fluid flows into the indicating chamber is not properly established by the fluid openings 72, the spout is unlikely to indicate an accurate dispensed fluid volume. Thus, being able to predict and control fluid flow rates through each of the fluid openings 72 is important. However, hydrodynamic aspects, such as hydraulic diameter, of the fluid openings 72 and of the fluids flowing through the fluid openings 72 make controlling the flow rates difficult. While conducting experiments related to this topic, we discovered several ways to improve the accuracy of prior art fluid dispensing systems. We begin with an explanation of some aspects of the problem.

FIG. 17 is a schematic diagram of a hypothetical fluid opening 1700, such as one of the fluid openings 72. As fluid flows through the opening 1700, a “skin” 1703 of fluid (indicated by hash lines) near the inner surfaces of the opening 1700 largely adheres to the inner surfaces, or it at least flows significantly slower than the main portion of the fluid stream. Because the skin 1703 largely adheres to the inner surfaces of the fluid opening 1700, the cross-sectional area of the skin 1703, i.e., the hashed area in FIG. 17, does not significantly contribute to the area of flow of the fluid through the fluid opening 1700.

The skin 1703 has a finite, although often irregular, thickness 1706 that depends on a number of factors, such as viscosity and chemistry of the fluid and hydrophilic/hydrophobic properties of the material that defines the fluid opening 1700. Other hydrodynamic effects also contribute to reducing the effective cross-sectional area of the fluid opening 1700, from the point of view of the rate at which fluid flows through the fluid opening 1700.

FIG. 18 is a schematic diagram of a hypothetical fluid opening 1800 that is smaller than the fluid opening 1700 of FIG. 17. As shown in FIG. 18, the skin thickness 1803 in the smaller fluid opening 1800 is substantially the same as in the larger fluid opening 1700. However, the reduction in effective cross-sectional area caused by the skin in the smaller fluid opening 1800 is larger, relative to the size of the fluid opening, than in the larger fluid opening 1700. Thus, if a mixture of sizes of fluid openings 72 (FIG. 10) is used, calculating appropriate sizes of the fluid openings 72 to achieve a desired ratio of: (a) fluid flow rate through the fluid outlet 26 (FIG. 2) to (b) fluid flow rate into the indicating chamber 32 (FIG. 2) is difficult for a given fluid.

Furthermore, if several fluids with different viscosities are to be accommodated by a single spout configuration, calculating appropriate sizes of the fluid openings 72 is even more difficult and may be impossible. It should be noted that some fluids, such as liquid laundry detergent, change viscosities with changes in temperature. Differences in temperature that can be expected in a home between summer and winter can cause changes in viscosity of liquid laundry detergent significant enough to make calculating sizes of the fluid openings 72 problematic or impossible. Consequently, accuracy of the indicated volume of dispensed fluid may be difficult to maintain, particularly if the fluid openings 72 leading to the fluid outlet 26 are sized differently than the fluid openings 72 leading to the indicating chamber 32.

We have found that all the fluid openings should be of equal size and shape, and the ratio of: (a) fluid flow rate to the fluid outlet 26 to (b) fluid flow rate to the indicating chamber 32 (“flow rate ratio”) should be controlled by a ratio of the number of fluid openings leading to the fluid outlet 26 to the number of fluid openings leading to the indicating chamber 32. Attempting to control the flow rate ratio by adjusting the size of each fluid opening 72 leading to the fluid outlet 26, as compared to the size of each fluid opening 72 leading to the indicating chamber 32, as in the prior art, is not likely to yield accurate dispensed fluid quantities, especially when the dispensed fluid's viscosity varies, such as with temperature.

FIG. 19 is a perspective illustration of an interior side of an exemplary covering lid that has five equal sized fluid openings 1900, according to an embodiment of the present invention, as contrasted with the covering lid shown in FIG. 10. The exemplary covering lid shown in FIG. 19 includes one fluid opening 1903 leading to the indicating chamber, and four fluid openings 1906 leading to the fluid outlet. However, in other embodiments, other ratios of the numbers of fluid openings 1900 may be used.

Using fluid openings 1900 all having the same size makes the fluid openings 1900 and, therefore, the flow rate ratio provided by the fluid openings 1900, insensitive to changes in viscosity of the fluid, because the change in flow rate through the fluid opening(s) 1900 that lead to the spout outlet is affected the same as the flow rate through other of the fluid opening(s) 1900 leading to the indicating chamber. Similarly, if several fluids with different viscosities are to be accommodated by a single spout configuration, uniformly sized fluid openings affect the fluid flow rate to the spout outlet the same as to the indicating chamber.

The fluid openings 1900 shown in FIG. 19 are arranged so as to be collinear. However, we have found that such an arrangement is not necessary to maintain accuracy. Similarly, we have found that other shapes, such as round, for the fluid openings 1900 perform adequately. However, as noted, all the fluid openings 1900 should have the same shape.

### Dosing Port Shape

Although rectangular or round fluid openings 1900 may be adequate, we have found that some other shapes provide advantages. To accurately indicate the amount of fluid dispensed, once a user has tilted a container into a pouring orientation, there should be little or no delay between the time fluid from the container reaches the fluid openings 1900 and the time the fluid begins flowing through the fluid openings 1900. In addition, ideally, fluid begins to flow essentially simultaneously through all of the fluid openings 1900. Otherwise, it is possible that fluid begins flowing into or through the pour chamber 30 (FIG. 6) before or after fluid begins flowing into the indicating chamber 32 (FIG. 6), thereby creating negative or positive offset (error) in the indicated amount.

Problematically, when the fluid from the container first reaches the fluid openings 1900 and forms a half drop extending through each fluid opening 1900, surface tension inside the half drop creates pressure preventing the fluid from flowing through the opening 1900 until the pressure of the fluid from the container overcomes the pressure of the surface tension. This causes a slight delay in the flow of fluid through the fluid opening 1900. The amount of surface tension and the amount of fluid pressure may be different at different ones of the fluid openings 1900, creating different delays for different fluid openings 1900, which can lead to errors in the indication of the amount of fluid dispensed.

We have found that fluid openings 1900 shaped to include inclusions or exclusions along their perimeters reduce surface tension and, therefore, facilitate a more consistent timing of the beginning of fluid flow among the fluid openings 1900. FIG. 23 schematically illustrates several exemplary shapes of fluid openings having sharp inclusions along their perimeters. Shapes 2300, 2303 and 2306 are star shapes, such as regular star polygons (2300 and 2303).

A “regular star polygon” is a self-intersecting, equilateral equiangular polygon, created by connecting one vertex of a simple, regular, p-sided polygon to another, non-adjacent vertex and continuing the process until the original vertex is reached again. Alternatively for integers p and q, it can be considered as being constructed by connecting every qth point out of p points regularly spaced in a circular placement. Other shapes, including other star shapes and irregular shapes may also be used.

The shape of a fluid opening may include irregularities along its perimeter, i.e., along its general shape. Such an irregularity may be in the form of an inclusion, i.e., a portion of the perimeter of the opening that extends into the opening. Shape 2300 has five sharp inclusions, exemplified by sharp inclusion 2309. As noted, the fluid openings need not be regular shapes. Shape 2312 is circular, except for a single somewhat “pie” shaped inclusion 2315. Shape 2318 is circular, except for two such “pie” shaped inclusions 2321 and 2324. Other numbers of inclusions may be used.

Optionally or alternatively, the irregularity along the perimeter of the fluid opening may be in the form of an exclusion, i.e., a portion of the perimeter of the opening that extends away from the opening, as exemplified by exclusion 2327 on shape 2330. A fluid opening may have a combination of inclusions and exclusions.

Crenated shape 2333 is another exemplary shape of a fluid opening having an inclusion 2336. Crenated shape 2333 has a margin with low, rounded or scalloped shapes. Although the term “crenated” is often used to describe an object, such as a leaf, rather than an opening, we used the term to describe the shape of a fluid opening.

The inclusions and exclusion shown in FIG. 23 are sharp, i.e, they include points. In some embodiments, the inclusions and/or exclusions may be smooth. FIG. 24 schematically illustrates examples of lobed fluid openings 2400 and 2403 (i.e., openings whose margins are shaped, at least in part, like lobes) and an irregular jagged shape 2406. In some embodiments, the fluid opening shapes may be similar to shapes of leaves, such as dentated, serrated, crenulated or lobed, although other shapes that reduce surface tension may be used.

FIG. 25 illustrates another configuration of a fluid opening 2500 that defines an aperture 2503. A wall 2506 extends from the plane 2509 of the aperture 2503 and surrounds the aperture 2503. An edge of the wall 2506 may define sharp, rounded or irregular shapes 2512 to break the surface tension. All the shapes 2512 need not be identical. Such an arrangement may resemble a “crown” placed around the aperture 2503. Although the crown shown in FIG. 25 has five points, any number of points or lobes may be used. The aperture 2503 may be circular, or it may have another shape. In some embodiments, exemplified in FIG. 25, bottoms of the valleys between the shapes 2512, exemplified by bottom 2515, do not reach the plane 2509. However, in other embodiments (not shown), the bottoms of the valleys reach the plane 2509, thereby leaving gaps in the wall 2506 between adjacent shapes 2512. Nevertheless, the wall 2506 is considered to surround the aperture 2503.

We use the term “sinuated” to cumulatively describe the shapes of fluid openings that reduce surface tension. A sinuated opening has a margin that bends or curves or winds in and out, in a plane or in three dimensions, as exemplified above.

Although sinuated fluid openings have been described in the context of a fluid dispensing system that indicates, in real time, a quantity of the fluid that has, thus far, been dispensed through the system in a single pour, sinuated fluid openings may be used in fluid dispensing systems that do not necessarily measure or indicate a volume of fluid that has been dispensed. In other words, sinuated fluid openings may be used in convention, non-metering spouts where there is a need or desire to reduce surface tension.

### Spout Drain/Air Transfer

We have found that another aspect of maintaining accuracy of the indicated dispensed fluid involves the way makeup air is introduced into the container, as fluid is being dispensed from the container. Allowing a smooth flow of makeup air, as opposed to allowing the makeup air to enter the container in a series of discrete volumes (“glugging”), provides more accuracy, at least because fluid enters the indicating chamber 32 smoothly, as opposed to in steps.

We have found that a “snorkel tube” arrangement is beneficial for introducing makeup air. Such a snorkel tube may also be used to drain fluid from the indicating chamber, once the spout is returned from its dispensing orientation back to its rest orientation. FIG. 20 is a cross-sectional view of a fluid dispensing system 2000, similar to the system 1200 shown in FIGS. 12-13, but that includes such a snorkel tube 2001. No shroud-cap is shown for simplicity. The fluid dispensing system 2000 is shown attached to a container 2003 and disposed in a dispensing orientation.

A heavy arrow 2006 indicates a path taken by fluid being dispensed though an outlet 2009. As the fluid is dispensed, additional fluid enters an indicating chamber 2012, as indicate by arrow 2015, in the manner described above. One end of the snorkel tube 2001 is in fluid communication with the top (as oriented in FIG. 20) of the indicating chamber 2012 to allow air to escape the indicating chamber 2012, as indicated by arrow 2021, as the indicating chamber 2012 fills with fluid. Optionally, the end of the snorkel tube 2001 that is in fluid communication with the indicating chamber 2012 may also be in fluid communication with the atmosphere outside the container 2003 to provide additional makeup air. The other end 2024 of the snorkel tube 2001 is disposed within the bottle. Air bubbles 2027 form as makeup air enters the container 2003.

The inside diameter of the snorkel 2001 is selected to reduce or eliminate the possibility of fluid entering the end 2024 of the snorkel tube 2001, while the fluid dispensing system 2000 is in a dispensing orientation. The inside diameter of the snorkel tube 2001 should be selected to be small enough to prevent such “backflow.” With a sufficiently small inside diameter, surface tension of the fluid, particularly with viscous fluids such as liquid laundry detergent, should prevent the fluid from entering the snorkel tube 2001 to an extent necessary to backflow to the indicating chamber 2012. In addition, the air flowing 2021 through the snorkel tube 2001 into the container 2003 inhibits fluid in the container from entering the end 2024 of the snorkel tube 2001.

We have found that the ratio of length 2030 to inside diameter of the snorkel tube 2001 may be selected to further deter or prevent fluid from the container 2003 from entering the end 2024 of the snorkel tube 2001. This ratio should be selected, based on the viscosity of the fluid, with less viscous fluids requiring larger ratios. We have found a ratio of about 7.76:1 to be acceptable, but ratios greater and less than this ratio may be used, depending on, for example, viscosity or other attributes of the fluid to be dispensed.

FIG. 21 is a cross-sectional view of the fluid dispensing system 2000 disposed in a rest orientation. As indicated by arrow 2100, in this orientation, fluid in the indicating chamber 2012 drains back into the container 2003 via the snorkel tube 2001.

Whether a snorkel tube is used or not, vent holes 42 (FIGS. 8 and 9) may be included to provide a path for makeup air to enter a container as fluid is being dispensed from the container, as well as to provide a path for air to escape the indicating chamber 32 as fluid from the container enters the indicating chamber 32. In some cases, when the container is tilted into a pouring orientation, fluid from the container reaches the general area of the vent holes 42 and submerges one or more of the vent holes 42. However, if air begins flowing through the vent holes 42 before the fluid reaches the vent holes 42, we have found that the air continues flowing through the vent holes 42, and the fluid generally does not enter the vent holes 42. Nevertheless, we have created some guidelines for positioning and sizing the vent holes 42, relative to the pour inlet 30A.

The vent holes 42 should be smaller than the pour inlet 30A. The vent holes 42 should be positioned such that, when the container is tilted into a pouring orientation, the vent holes 42 are higher than the pour inlet 30A, as shown schematically in FIG. 26. If no snorkel tube is included, the vent holes 42 and the pour inlet 30A may be substantially coplanar, as best seen in FIG. 8. If the fluid opening shapes are sinuated to reduce surface tension, the vent holes may be shaped so as to increase surface tension, thereby inhibiting entry of fluid from the container into the vent holes, while promoting entry of the fluid into the fluid openings.

When the container is tilted to a pouring orientation, the two small vent holes 42 (FIG. 8) proximate the indicating inlet 34 allow air to escape the indicating chamber 32 and flow into the container, as fluid from the container enters the indicating chamber 32. Two larger vent holes 42 allow makeup air to enter the container. When the container is returned to a rest orientation, two small vent holes 42 on the dividing wall 44 allow makeup air to enter the indicating chamber 32, as the fluid in the indicating chamber 32 flows returns to the container. We have found that including more than one vent hole in each of these locations provides advantages over a single vent hole. For example, if one of several vent holes becomes blocked, the remaining vent holes still provide ventilation, thereby avoid glugging.

In addition, as schematically illustrated in FIG. 27, we have found that positioning the small vent holes 42 (which ventilate the indicating chamber 32) below the bottom of the indicating inlet 34 (as shown by dashed line 2700) and/or positioned or spaced apart such that the vent holes 42 are not within view through the transparent wall of the indicating chamber 32 provides advantages. For example if, during a pour, fluid from the container leaks through the vent holes 42 into the indicating chamber 32, the leaking is not visible or is not apparent to a user, because fluid in the indicating chamber 32 obscures the leaking fluid and/or the non-transparent portion of the indicating chamber 32 masks the view of the leaking fluid.

### Isolation Wall

Ideally, when dispensing fluid using a fluid dispensing system, the indicating chamber should visibly begin filling at the same time as fluid begins visibly exiting the spout outlet. If these two events do not occur substantially simultaneously, at least within the use's perception, the user may become concerned that the volume indicated by the indicating chamber is inaccurate.

Referring, for example, to FIG. 20, if the path 2015 followed by fluid from the container 2003 to the indicating chamber 2012 is different in volume than the path 2006 followed by fluid from the container 2003 to the spout outlet 2009, the indicating chamber 2012 may begin filling before or after fluid begins exiting the spout outlet 2009, depending on which path has the greater volume.

Furthermore, some fluid dispensing systems include a gutter, exemplified by gutter 2103 (FIG. 21), surrounding the spout outlet 2009. When the container 2003 is returned to the rest position after dispensing fluid, any fluid on the outside of the spout outlet 2009 runs down the outside of the spout outlet 2009, into the gutter 2103, and then joins 2106 fluid draining from the indicating chamber 2012 back into the container 2003. Some fluid dispensing systems include voids, exemplified by voids 2109 and 2112. Such voids often exist in fluid dispensing systems with off-center spout outlets 2009 or in systems configured to be used with containers 2003 having elongated cross sections.

Problematically, in a dispensing orientation (FIG. 20), these voids fill with fluid that has passed through the fluid openings 72 (FIG. 10) or 1900 (FIG. 19). However, this fluid does not exit the spout outlet 2009, thereby delaying onset of visible fluid flow exiting the spout outlet 2009. Meanwhile, the indicating chamber 2012 may begin visibly filling, leading to an inaccurate indication of dispensed fluid volume.

We solve this problem by including one or more isolation walls, exemplified by isolation walls 2115 and 2118 (FIG. 21), to prevent fluid from entering the voids 2109 and 2112, respectively.

### Controlled Dosing

Returning to the dosing ports 1900 described above, with respect to FIG. 19, the total area of the dosing ports 1900 that lead to the spout outlet should be selected such that, for anticipated viscosities or ranges of viscosities of dispensed fluids, the amount of time required to dispense an anticipated amount of the fluid will be reasonable to an expected user. For example, if liquid laundry detergent will be dispensed, the total area of the dosing ports 1900 leading to the spout outlet should be selected such that the time required to dispense an amount sufficient for one load of laundry is not excessive.

On the other hand, the total area of the dosing ports 1900 that lead to the indicating chamber should be selected such that the time to dispense the expected volume is not unreasonably short to the expected user. The minimum amount of time to dispense the expected volume should be long enough to allow the user to read the indicating chamber and suspend or cease dispensing fluid before the expected volume has been dispensed. For example, if the amount of laundry detergent expected to be dispensed for one load of laundry is one-quarter cup, the dosing ports 1900 should be configured such that the detergent is dispensed slowly enough for a typical user to observe the indicating chamber fill and suspend or cease dispensing the detergent after less than one-quarter cup has been dispensed. We have found, for example, that a dispensing rate at or above about 30 ml per second is too high for most users.

There may be a tradeoff between configuring the number, size and ratio of the dosing ports so as to meet both objectives, i.e., not dispensing too slowly and not filling the indicating chamber too quickly. We have found that slower dispensing tends to yield more accurate measurement. Thus, the dispensing and measuring rates should be low, although not low enough to frustrate a typical expected user. We have found that metered pour inlets and metered indicating inlets configured such that, in use, an expected quantity of the fluid exits the outlet in no less than about 0.5 seconds and no more than about 30 seconds are acceptable.

### Pre-Angled Indicating Chamber

We have found that accuracy depends, in part, on verticality of the indicating chamber, while dispensing fluid. The more vertical the indicating chamber, the more accurate the volumetric reading. FIG. 22 shows a fluid dispensing system 2000 attached to a container and disposed in a dispensing orientation (“dispensing angle”), indicated by an axis 2200 of the fluid dispensing system 2000 and the container 2003 (a longitudinal axis of the container 2003). The dispensing orientation employed by a user may be influenced by the configuration, such as size, cross-sectional shape, etc., of the container 2003 and/or by the configuration of the fluid dispensing system 2000. Furthermore, if the container 2003 or the system 2000 includes a handle (not shown), the angle of the handle, relative to the container 2003 or the system 2000, may influence how the user grasps the handle and, therefore, the dispensing angle. Thus, based on the configuration of the container 2003 and/or the system 2000, it may be possible to predict an approximate dispensing angle that users will employ.

Based on the predicted dispensing angle, the indicating chamber 2012 may be oriented, relative to the axis 2200 of the fluid dispensing system 2000, so the indicating chamber 2012 will be oriented substantially vertically, as indicated by dashed line 2203, when the system 2000 is in use. We have found that for conventionally-configured containers, users typically employ dispensing angles of about 45°, relative to horizontal. Thus, the indicating chamber 2012 may be oriented, relative to the axis 2200 of the fluid dispensing system 2000, so the indicating chamber 2012 is oriented substantially vertically when the axis 2200 of the fluid dispensing system 2000 is oriented about 45°, relative to horizontal. Other appropriate angles, such as between about 40° and about 75° or between about 30° and about 60° may be used.

### Flexible Package Embodiment

Some products are provided in squeezable foil (metal, plastic, metalized plastic, etc.) bags, commonly referred to as “flexible packages.” Product may be dispensed from such a package by squeezing the package, as is well known in the art. A flexible package is also referred to herein as a flexible container.

A volume-indicating spout, similar in construction and operation to the spout 1200 described above with respect to FIGS. 12 and 13, may be fitted to a flexible container, as shown schematically in FIG. 28. The spout 2800 may be fitted to the flexible container 2803 via a threaded connection, ribbed connection, induction welding, ultrasonic welding, press fitting, barbed fitting or any other suitable fitting. FIGS. 29 and 30 schematically illustrate one such embodiment, in which the spout 2800 (for clarity, shown slightly larger than in FIG. 28) includes pouch fitment ribs 2900 for fitting to a flexible container. A shroud-cap 2903 is shown in a closed position in FIG. 29 and in an open position in FIG. 30. In the open position, the shroud-cap 2903 reveals an indicator window 2906, a dose tube 2909 and a sealing spud 2912. When the shroud-cap 2903 is closed, the sealing spud 2912 seals the dose tube 2909.

As described above, such as with respect to FIGS. 2 and 8, the indicating chamber may vent to the interior of the flexible container, so that, while dispensing fluid, air escapes the indicating chamber into the flexible container, as fluid from the flexible container enters the indicating chamber. However, in other embodiments, the indicating chamber is vented to only the exterior of the flexible container. In most embodiments, the interior of the flexible container is not vented to the atmosphere outside the flexible container.

FIG. 31 is a cross-sectional view of a spout 3100, in which the indicating chamber 3103 is vented to only the exterior of the flexible container. Parallel angled walls 3106 and 3109 partially define the indicating chamber 3103. The angle facilitates drainback of fluid from the indicating chamber 3103 into the flexible container, once the flexible container is returned to a rest orientation. Wall 3109 may be transparent with indicia, as described above. One or more metered indicating inlets (not visible in FIG. 31) provide a fluid path from the interior of the flexible container to the indicating chamber 3103. An indicating chamber vent tube 3112 vents the indicating chamber 3103 to the exterior of the flexible container. The spout 3100 also includes a dose tube 3115, which includes a metered pour inlet 3118. A shroud-cap 3121 includes a dose tube sealing spud 3124 and a vent tube sealing spud 3127 which, when closed, seal the dose tube 3115 and the indicating chamber vent tube 3112, respectively.

Thus, in use, when the flexible container is tilted to a dispensing orientation, fluid flows from the flexible container, through the dose tube 3015, and is, thereby, dispensed. At the same time, fluid is forced from the flexible container into the indicating chamber 3103 via the one or more metered indicating inlets (not visible). Air escapes the indicating chamber 3103 via the indicating chamber vent tube 3112. When the container is returned to a rest orientation, the fluid in the indicating chamber 3103 flows under the force of gravity back into the flexible container, and makeup air is drawn, via the indicating chamber vent tube 3112, back into the indicating chamber 3003.

Although the one or more metered indicating inlets provide a fluid path between the interior of the flexible container and the indicating chamber 3103, this fluid path is not used to vent the indicating chamber 3103 as the indicating chamber 3103 fills with fluid from the flexible container. Similarly, this fluid path does not provide makeup air while the indicating chamber 3103 empties after use. Thus, as used herein, the indicating chamber 3103 is referred to as being vented to only the exterior of the flexible container.

As shown in FIG. 32, the indicating chamber vent tube 3112 extends into the indicating chamber 3103 a distance, such that even if the indicating chamber 3103 becomes quite full (as indicated by dashed line 3200), the fluid in the indicating chamber 3103 does not overflow into the top 3203 of the indicating chamber vent tube 3112.

While the invention is described through the above-described exemplary embodiments, it will be understood by those of ordinary skill in the art that modifications to, and variations of, the illustrated embodiments may be made without departing from the inventive concepts disclosed herein. Furthermore, disclosed aspects, or portions of these aspects, may be combined in ways not listed above. Accordingly, the invention should not be viewed as being limited to the disclosed embodiments.

What is claimed is:

1. Apparatus for dispensing fluid from an interior of a container and for indicating, in real time, a quantity of the fluid that has, thus far, been dispensed through the apparatus in a single pour, the apparatus comprising:
an outlet;
an indicating chamber;
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet; and
a cap configured to selectively toggle between a first orientation and a second orientation, wherein in the first orientation the cap closes the outlet and obscures the indicating chamber from view by a user, and in the second orientation the cap opens the outlet and reveals the indicating chamber for view by the user.

2. Apparatus for dispensing fluid from an interior of a container and for indicating, in real time, a quantity of the fluid that has, thus far, been dispensed through the apparatus in a single pour, the apparatus comprising:
an outlet;
an indicating chamber; and
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet;
wherein the metered pour inlet defines at least one metered inlet aperture and the metered indicating inlet defines at least one metered indicating aperture, all the metered inlet apertures and the metered indicating apertures having substantially identical sizes and shapes.

3. Apparatus as defined in claim 2, wherein the shapes of the metered inlet apertures and the shapes of the metered indicating apertures comprise sinuated shapes.

4. Apparatus as defined in claim 3, wherein the metered inlet apertures and the metered indicating apertures are star shaped.

5. Apparatus as defined in claim 3, wherein, for each of the at least one metered indicating aperture, the metered indicating inlet comprises a wall extending from a plane of the metered indicating aperture and surrounding the metered indicating aperture.

6. Apparatus as defined in claim 5, wherein an edge of the wall defines a plurality of shapes, wherein each shape is selected from a list consisting of sharp, rounded and irregular.

7. Apparatus for dispensing fluid from an interior of a container and for indicating, in real time, a quantity of the fluid that has, thus far, been dispensed through the apparatus in a single pour, the apparatus comprising:
an outlet;
an indicating chamber;
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet; and
a snorkel tube, one end of which is in fluid communication with the indicating chamber, the other end of which is configured to extend into the container.

8. Apparatus as defined in claim 7, wherein the end of the snorkel tube that is in fluid communication with the indicating chamber is configured to be in fluid communication with an exterior of the container.

9. Apparatus as defined in claim 7, wherein the snorkel tube is configured to have a length to inside diameter ratio of about 7.76 to 1.

10. Apparatus for dispensing fluid from an interior of a container and for indicating, in real time, a quantity of the fluid that has, thus far, been dispensed through the apparatus in a single pour, the apparatus comprising:
an outlet;
an indicating chamber;
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet; wherein:
the housing defines at least one vent hole along a vent path, one end of the vent path being in fluid communication with an interior of the container, the other end of the vent path being in fluid communication with an exterior of the container;
the metered pour inlet and the vent hole are substantially coplanar; and
the housing is configured such that, when the apparatus is oriented at an expected dispensing angle, the at least one vent hole is higher than the metered pour inlet.

11. Apparatus for dispensing fluid from an interior of a container and for indicating, in real time, a quantity of the fluid that has, thus far, been dispensed through the apparatus in a single pour, the apparatus comprising:
an outlet;
an indicating chamber; and
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet;
wherein the first fluid path and the second fluid path are configured such that, in use, the indicating chamber begins to visibly fill with fluid at substantially the same time as fluid begins to exit the outlet, within perception limits of a human user.

12. Apparatus for dispensing fluid from an interior of a container and for indicating, in real time, a quantity of the fluid that has, thus far, been dispensed through the apparatus in a single pour, the apparatus comprising:
an outlet;
an indicating chamber; and
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet;
wherein the metered pour inlet and the metered indicating inlet are configured such that, in use, an expected quantity of the fluid exits the outlet in no less than about 0.5 seconds and no more than about 30 seconds.

13. Apparatus for dispensing fluid from an interior of a container and for indicating, in real time, a quantity of the fluid that has, thus far, been dispensed through the apparatus in a single pour, the apparatus comprising:
an outlet;
an indicating chamber having a longitudinal axis configured such that, when the apparatus is oriented at an expected dispensing angle, the longitudinal axis of the indicating chamber is substantially vertical; and
a housing defining a first fluid path from the interior of the container, via a metered pour inlet, to the outlet and a second fluid path from the interior of the container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet.

14. Apparatus for dispensing fluid from an interior of a flexible container and for indicating, in real time, a quantity of the fluid that has, thus far, been dispensed through the apparatus in a single pour, the apparatus comprising:
an outlet;
an indicating chamber vented to only an exterior of the flexible container; and
a housing defining a first fluid path from the interior of the flexible container, via a metered pour inlet, to the outlet and a second fluid path from the interior of the flexible container, via a metered indicating inlet, to the indicating chamber, wherein the metered indicating inlet and the metered pour inlet are sized such that a rate at which the fluid flows through the indicating inlet is related to a rate at which the fluid flows through the outlet, and such that a quantity of fluid received into the indicating chamber relates in real time to a quantity of fluid that has thus far exited through the outlet.

15. Apparatus as defined in claim 14, wherein the flexible container is not vented to an exterior of the flexible container.
